(19) United States
(12) Patent Application Publication
(10) Pub. No.: US 2005/0137949 A1
(43) Pub. Date: Jun. 23, 2005

(54) Automatic, characterized and prioritized transactions to credit card accounts from one credit card account, method and computer software

(76) Inventors: Danny Rittman, Folsom, CA (US); Moshe Schnapp, West Hollywood, CA (US)

Correspondence Address: DANNY RITTMAN, 250 McAdoo Drive # 512, FOLSOM, CA, 95630, US

(21) Appl. No.: 10/737,093

(22) Filed: Dec. 17, 2003

(51) Int. Cl. G06F 17/60; G06F 17/00

(52) U.S. Cl. 705/35; 707/100

(57) ABSTRACT

This paper describes a system and a computer software invention for automatic characterized and prioritized credit cards transactions and charge system. Typical credit cards accounts are categorized by their characters. These characters are offered by the credit cards corporations to its customers and include best interest rates, membership fees, cash advanced, line of credit, benefits like mileage, gift certificates, and similar. When a credit card user is using his/hers account, most of the cases it is done arbitrarily or by credit availability. In many cases the credit card user is not utilizing his/hers other cards lower interests and benefits. Using an automated software tool and method, as we will describe in this invention, a credit card user combines all of his/hers credits cards accounts into one credit facilitate account. This one credit system, automatically prioritize and charges the best credit card account according to the user's best interest, furthermore it will combine all the line of credits from his/her credit cards into one “big” line of credit. The one credit system accumulates the users' credit cards available credit into one account. When a transaction is made, the system searches the user's most beneficial credit card account and charges the amount to it. The most beneficial account is defined by the system according to its characteristics and benefits. These characteristics are low interest, additional benefits (mileage, gift points, etc') provided by credit cards corporations and/or financial institutions. The system may automatically split the full amount between few accounts for the best interest rate and/or other benefits. The user gets a monthly statement that shows the total charges and makes one payment which will be distributed among the different credit card accounts that he/she combined to the one credit card account. The statement shows to which account the charge was made and the reasons for the credit card account selection. Also the system provides a minimal payment due to cover all necessary credit card accounts. User can setup the system to pay the minimum amount required or more according to desire. Using this system, method and computer software user may save enormous amount of money and gain all the possible additional benefits using their credit cards. The system is a secured web based computer software and method that allows users to define and prioritized their credit accounts for automatic selection according to priorities and benefits. The system automatically identifies the user's credit accounts limits and availability and charges the best amount for the user's best benefits. The system also covers refunds in a similar way. All refunds will be credited to the best credit account(s) according to the user's preset priorities.

### BACKGROUND OF THE INVENTION

1. Field of the Invention

The present invention relates generally to a credit card automated billing system used by retailers who sell goods or services, and more particularly, to an improved automated billing system which facilitates the distribution of charges for such goods or services on multiple credit cards in such a manner to financially benefit the customer, taking into account lowest interest rate and better credit card benefits.

2. Background of the Invention

Consumers often purchase goods or services with a limited understanding of the interest rate, card benefits (like mileage accumulation and similar), or to obtain a free incentive being offered by the remote retailer to induce the purchase of the goods or services. This results the consumer's poor financial management. When the charge for the purchased goods or services ultimately appears on the consumer's credit card billing statement the consumer becomes aware to the fact of paying high interest and/or losing benefits. This condition creates millions of credit card consumers that are in high debt.

When a consumer is placing a charge to a credit card, typically he/she do not take the time to verify the interest rate and the benefits of the used card. Moreover many credit cards offer very low interest rate for the first one (1) year hence after this period the interest rate automatically becomes significantly higher which cause the consumer to lose money.

The tendency of the consumer to purchase using credit card is often compounded by the consumer's unfamiliarity with the credit card's interest rate and benefits. In addition, this tendency is further compounded by the industry practice of offering tempting credit cards in a very low interest rate for the first one year. After a period of one year the credit card's interest rate raises significantly causing the consumer to pay high monthly payment. Ultimately millions of consumers are going in debt due to the high interest rates that are automatically charged to their credit card account monthly. In additional the user is not aware to credit card benefits (for example mileage accusation plan) and is not utilizing them.

Having improved and automate distributed charging system, preventing consumers from using high interest credit cards and therefore will result a significant funds saving and debt prevention. Another advantage is the utilization of credit cards benefits for the consumer's satisfactory.

### SUMMARY OF THE INVENTION

It is a primary object of the present invention to provide a method and system that automatically distributes charge into user's credit account(s) according to best interest rate and other benefits. Typical credit cards accounts are categorized by their characters. These characters are offered by the credit cards corporations to its customers and include best interest rates, membership fees, cash advanced, line of credit, benefits like mileage, gift certificates, and similar. Using an automated software tool and method, as we will describe in this invention, a credit card user combines all of his/hers credits cards accounts into one credit facilitate account. This one credit system, automatically prioritize and charges the best credit card account according to the user's best interest, furthermore it will combine all the line of credits from his/her credit cards into one “big” line of credit. The one credit system accumulates the users' credit cards available credit into one account. When a transaction is made, the system searches the user's most beneficial credit card account and charges the amount to it. The most beneficial account(s) is defined by the system according to its characteristics and benefits. These characteristics are low interest, additional benefits (mileage, gift points, etc') provided by credit cards corporations and/or financial institutions. The system may automatically split the full amount between few accounts for the best interest rate and/or other benefits. The user gets a monthly statement that shows the total charges and makes one payment which will be distributed among the different credit card accounts that he/she combined to the one credit card account. The statement shows to which account the charge was made and the reasons for the credit card account selection. Also the system provides a minimal payment due to cover all necessary credit card accounts. User can setup the system to pay the minimum amount required or more according to desire. Using this system, method and computer software user may save enormous amount of money and gain all the possible additional benefits using their credit cards. The system is a secured web based computer software and method that allows users to define and prioritized their credit accounts for automatic selection according to priorities and benefits. The system automatically identifies the user's credit accounts limits and availability and charges the best amount for the user's best benefits. The system also covers refunds in a similar way. All refunds will be credited to the best credit account(s) according to the user's preset priorities.

The system is computer software that is connected to credit card accounts database and has the capability to charge or credit each credit card account. The system is based on Artificial Intelligence (Al) algorithm to analyze each account according to the accounts interest rate and benefits. The system combines all credit card accounts into one credit card account. Each time that a charge or credit is placed within this one credit card; the system automatically distributes the charge or credit to the available credit card account(s) according to the lowest interest rate and benefits. This is done for the user's best interest in order to save a significant amount of money over time. The system supports web based application and/or client server independent application that is connected to credit card accounts database. The system produces a monthly statement including all charges that were made to each account based on the system analysis.

A more complete understanding of the present invention, as well as further features and advantages of the present invention, will be obtained by reference to the following detailed description and drawings.

### BRIEF DESCRIPTION OF THE DRAWINGS

FIG. 1 schematically illustrates the system's concept. One credit card account transactions are automatically distributed between all users' available credit card accounts.

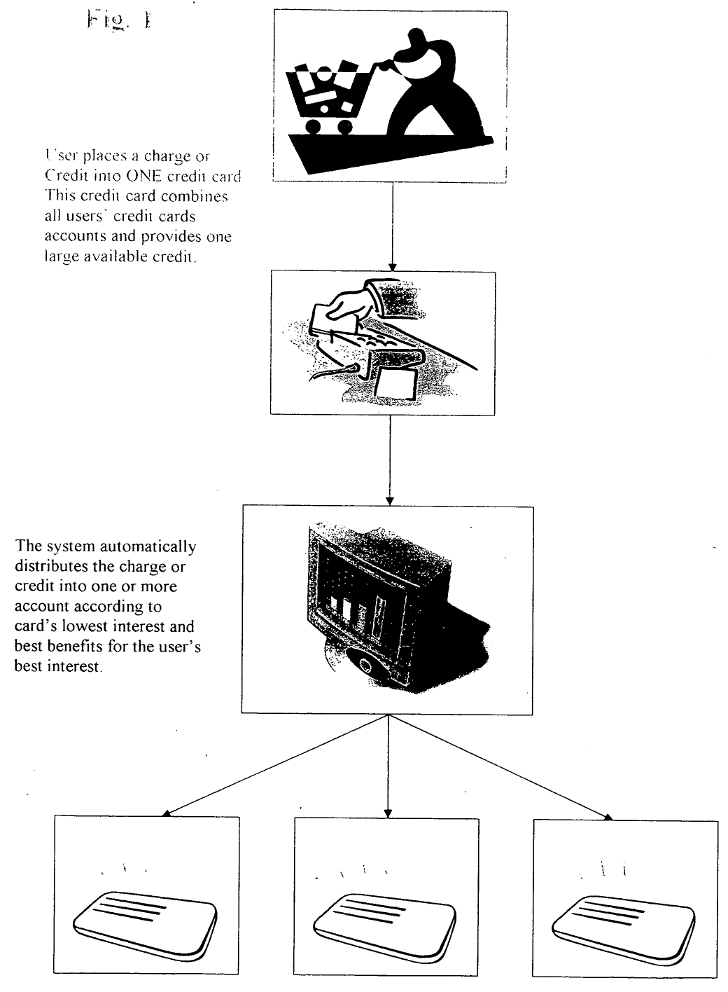

FIG. 2 schematically illustrates the system's operation flow. When the user's makes charge or credit to one credit card account, the system analyze all available accounts for lowest interest and benefits and re-routed the charges to the user's best credit card account.

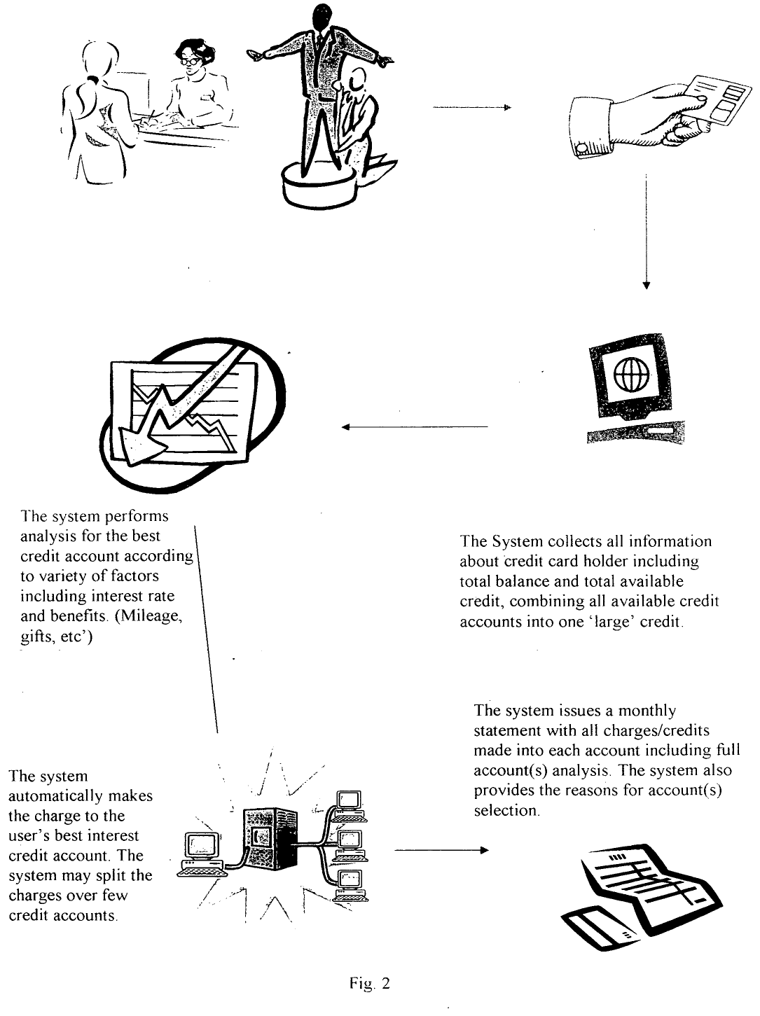

FIG. 3 is a flow diagram outlining the technique of the present invention for automatic distribution of charges or credits into credit account(s)

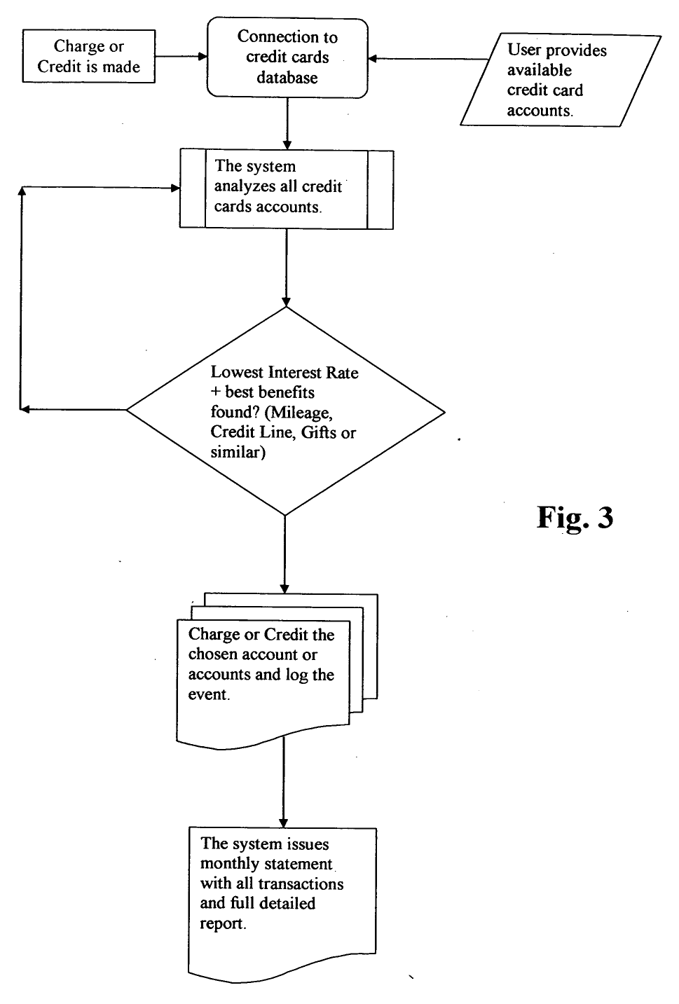

1. An automated system for combining authorized credit accounts into one credit card account, comprising:
performing an electronic information input process in which input information is received, including a manual input of account identification information sufficient to identify a particular one of said individual credit financial accounts and a financial institution holding said account, and amount information defining an amount to be charged or credited to said user;

2. A process for making automated payments from the one credit card account to other credit cards accounts based on software authorization, comprising the steps of:
providing an automated computing system that connected to credit cards accounts database for receiving input information;
conducting a to the computing system, in which said system obtains said input information, including at least identification of said financial account and a credit financial institution identification code identifying said credit financial institution holding said credit financial account, and contemporaneously enters said input information in said input;
using said computing system, automatically verifying said credit financial institution identification code contemporaneously with system entry of said input information, by comparing said code to entries in an institutional database and determining whether said code matches an entry in the database;

3. The process of claim 2 wherein said the computing system obtain in separated components, the credit card accounts benefits for further analysis;

4. An automated process for charging the most beneficial credit card account based on credit card lowest interest rate and benefits, comprising the steps of:
providing automated information, taken from credit card accounts database about each credit card account interest rate and benefits information;

5. Automated apparatus and software for generating credit card accounts interest and benefits, comprising:
electronic circuits hardware to establish physical connection to credit card account database information;
an institutional database of financial institution information;
validity verification means for retrieving a record from said credit institutional database corresponding to the user's financial institution said account identifier according to an algorithm established for the user's financial institution to determine whether said account identifier can be a valid account identifier, and providing an output indication during the manual input process if such account establishes that said account identifier may be invalid; and

6. A standalone computer program for receiving input information and automatically analyze credit card accounts information; said credit card accounts benefits are mileage accumulating program, gift certificates and others.

7. An automated method and computer software to analyze the given credit card accounts information and provide the most beneficial credit card account to be charged or credit for guarantying the lowest interest rate and benefits for the user's best interest, comprising:
given credit card accounts information means for performing an electronic information input process wherein the computer software receives information including a financial institution identification number, user's account identifier, interest rate, current balance, available balance and account benefits;
an institutional database comprising financial institution identification information;
institution verification means for receiving said financial institution identification number and comparing said financial institution identification number to entries in said institutional database, wherein when said financial institution is found in the institutional database, the institution verification means retrieves identifying information about the institution and verifies the accuracy of said financial institution identification number, and wherein when said financial institution is not found in the institutional database, an error indication is generated;
processing means connected to said input means for receiving said input information and processing said information to analyze accounts information to charge the user's best interest credit account according to interest rate and account benefit;

8. An automated method and algorithm for generating a monthly statement that provides all information about all given credit card accounts and the charges and refunds that were made to each credit card account, comprising:
all charges and/or refunds information that were made by the system; and
detailed report for choosing particular credit card account(s) for charges or credits;
detailed description of the charge or credit routed to the user's most beneficial credit card account(s);

9. An algorithm to automatically distribute charges or credits to few credit accounts according to user's best interest, comprising:
credit card accounts analysis to determine user's best value wherein said best value are credit card account features wherein said credit card account features are lowest interest rate and benefits;
benefits are credit card account additional features including mileage redemption program, gifts, line of credit and similar.

10. An automated distributed payment processing system for generating a plurality of authorized payments to credit financial accounts belonging to a plurality of users.

11. The system of claim 10 wherein said automated distributed payment processing further comprise:
a local or remote institutional database comprising credit financial institution identification and verification information; and
institution verification means associated with said database for receiving said credit financial institution identification number and comparing said credit financial institution identification number to entries in said credit institutional database, wherein when said credit financial institution is found in the institutional database, the institution verification means retrieves identifying information about the institution and verifies the accuracy of said financial institution identification number, and wherein when said financial institution is not found in the institutional database, an error indication is generated.

12. The system of claim 11 wherein said input means provides a single input with fields for receiving a user name, user identifying information, credit financial institution identification number, user account identifier, and the amount to be charged or credited from said user's account.

13. The system of claim 1 is an internet based application and also supports independent client server application.

14. The system of claim 1 includes 128 bit encryption security algorithm to provide confidentiality and security.

15. The system of claim 1 supports international credit accounts and supports all credit cards financial institutions world wide.

16. The system of claim 1 supports all types of charges or credits transactions, said merchant store, internet on-line secure web site and/or via telephone.
